(19) United States
(12) Patent Application Publication
(10) Pub. No.: US 2004/0123711 A1
(43) Pub. Date: Jul. 1, 2004

(54) Fully automatic cutting metal-working machine

(76) Inventor: Chin Chung Cheng, Kaohsiung Hsien (TW)

Correspondence Address: PRO-TECHTOR INTERNATIONAL, 20775 Norada Court, Saratoga, CA, 95070-3018, US

(21) Appl. No.: 10/338,304

(22) Filed: Jan. 7, 2003

(51) Int. Cl. B26D 7/06; B26D 1/18; B23D 19/00

(52) U.S. Cl. 83/154; 83/483

(57) ABSTRACT

A fully automatic cutting metal-working machine is disclosed to include cutting metal-working main unit controlled to process a metal rod material into finished products, and a material feed unit adapted to feed a metal rod material to the cutting metal-working main unit for processing, the material feed unit having a feed pipe for feeding the provided metal rod material, a pipe carrier carrying the feed pipe, a power unit controlled to drive the pipe carrier to move the feed pipe forwards/backwards between an extended position and a received position, and a holding down mechanism installed in the distal end of the feed pipe and controlled to hold down the inserted metal rod material for cutting.

### BACKGROUND OF THE INVENTION

1. Field of the Invention

The present invention relates to a fully automatic cutting metal-working machine and, more specifically, to an improvement on the material feed unit of a fully automatic cutting metal-working machine.

2. Brief Description of the Related Art:

U.S. Pat. No. 6,119,330, issued to the present inventor, discloses a fully automatic cutting metal-working machine, which includes a circular cutting metal-working main unit, a material feed unit, a waste material conveyer, and a control box (not shown). The cutting metal-working main unit comprises a machine base 1′, a casing 2′, a rotary center fixture holder 3′, a material cut-off shaft assembly 4′, a set of processing shaft assemblies 5′, and a steering shaft assembly 6′. The material cut-off shaft assembly 4′ and the processing shaft assemblies 5′ each are equipped with a motor, which provides the necessary working power. When a metal rod material 40′ fed by the material feed unit to one fixture 31′ of the center rotary fixture holder 3′ through a feed pipe 201′, the corresponding fixture 31′ holds down the metal rod material 40′, and then the metal rod material 40′ is cut by the cutting tool 46′ of the material cut-off shaft assembly 4′, enabling each cut piece of the metal rod material 40′ to be used as a workpiece, which is then carried by the fixture 31′ to the processing shaft assemblies 5′ to receive different processing processes. This structure of fully automatic cutting metal-working machine is functional, however it still has minor drawbacks. When one fixture 31′ of the center rotary fixture holder 3′ holding down one end of the metal rod material 40′, the other end of the metal rod material 40′ is suspended in the feed pipe 201′ and not firmly held down. Therefore, the cutting tool 46′ of the material cut-off shaft assembly 4′ may vibrate when cutting the metal rod material 40′ (See FIG. 3). Furthermore, if the gap D between the feed pipe 201′ and the fixture 31′ is smaller than the length of the residual metal rod material 402′, the residual metal rod material 402′ may be jammed in between the feed pipe 201′ and the fixture 31′. At this time, the operator must shut down the machine and then remove the residual metal rod material 402′ manually.

### SUMMARY OF THE INVENTION

The present invention has been accomplished under the circumstances in view. According to one aspect of the present invention, the material feed unit of the fully automatic cutting metal-working machine comprises a feed pipe for feeding a metal rod material for cutting, a pipe carrier carrying the feed pipe, a power unit controlled to drive the pipe carrier to move the feed pipe forwards/backwards between an extended position and a received position. According to another aspect of the present invention, the material feed unit further comprises a holding down mechanism installed in the distal end of the feed pipe and controlled to hold down the inserted metal rod material for cutting.

### BRIEF DESCRIPTION OF THE DRAWINGS

FIG. 1 is a schematic top view of a fully automatic cutting metal-working machine according to U.S. Pat. No. 6,119,330.

FIG. 2 is a schematic drawing showing the residual metal rod material jammed in the machine according to the prior art.

FIG. 3 is a schematic side view showing the operation of the fully automatic cutting metal-working machine according to the prior art.

FIG. 4 is a side plain view of a fully automatic cutting metal-working machine according to the present invention.

FIG. 5 is a schematic drawing showing the operation of the fully automatic cutting metal-working machine according to the present invention (I).

FIG. 6 is a schematic drawing showing the operation of the fully automatic cutting metal-working machine according to the present invention (II).

FIG. 7 is an enlarged view of part A of FIG. 5.

FIG. 8 is a sectional view taken along line A′-A′ of FIG. 7.

FIG. 9 is similar to FIG. 8 but showing the pressure rod pressed on the pressure block against the metal rod material.

### DETAILED DESCRIPTION OF THE PREFERRED EMBODIMENT

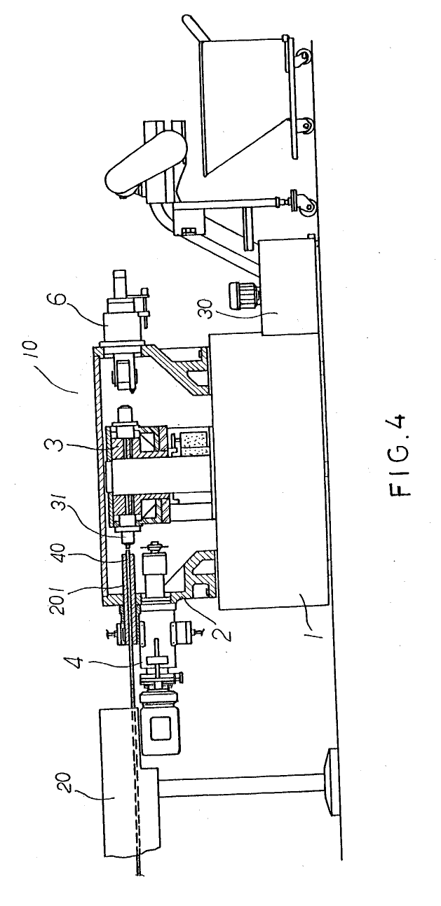

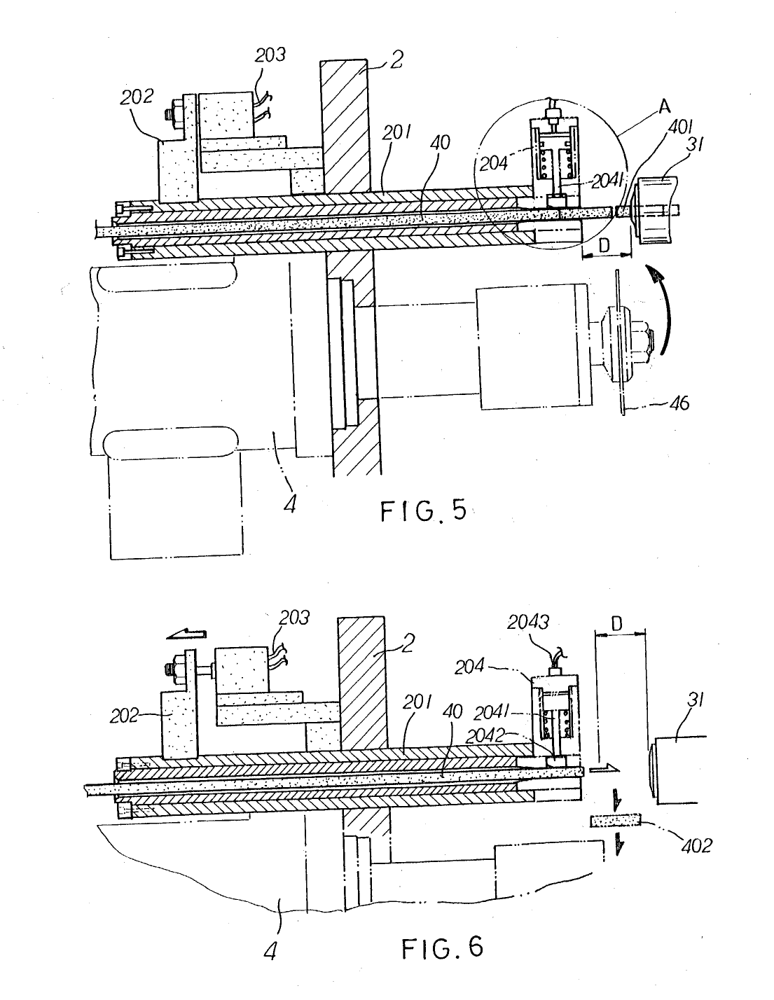

Referring to FIGS. 4 and 5, a fully automatic cutting metal-working machine is shown comprised of a circular cutting metal-working main unit 10, a material feed unit 20, a waste material conveyer 30, and a control box (not shown). The cutting metal-working main unit 10 comprises a machine base 1, a casing 2, a rotary center fixture holder 3, a material cut-off shaft assembly 4, a set of processing shaft assemblies 5, and a steering shaft assembly 6. The material cut-off shaft assembly 4 and the processing shaft assemblies 5 each are equipped with a motor 50, which provides the necessary working power.

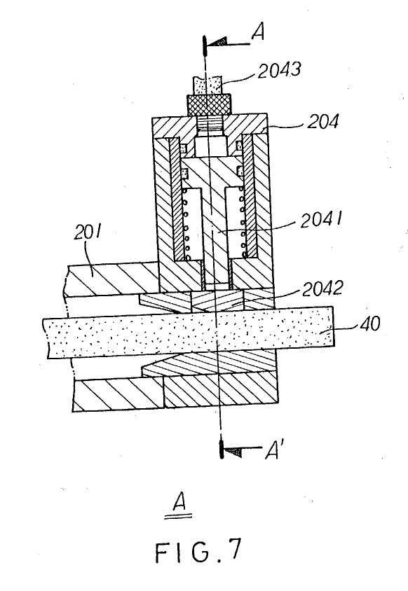

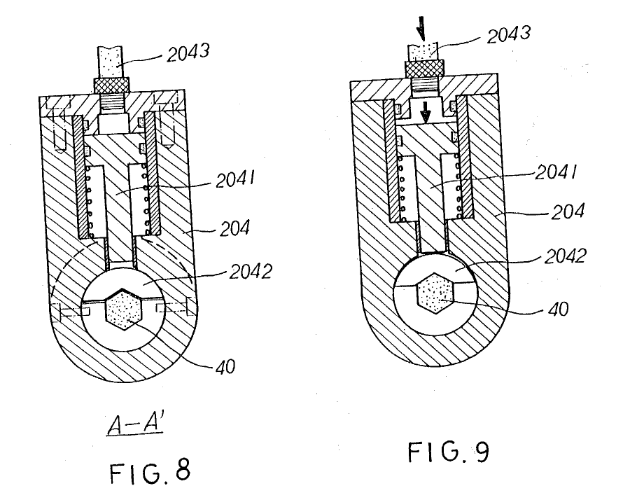

The rotary center fixture holder 3 is mounted inside the casing 2 at the center, comprising a plurality of fixtures 31 equiangularly spaced around its periphery corresponding to the shaft assemblies 4, 5, and 6. The material feed unit 20 comprises a forwardly extended feed pipe 201 at its front side for delivering a metal rod material 40 to the fixture 31 for cutting by the cutting tool 46 of the material cut-off shaft assembly 4, a pipe carrier 202 holding the feed pipe 201, a power unit 203 controlled by the control box (not shown) of the cutting metal-working machine to drive the pipe carrier 202 to move the feed pipe 201 forwards/backwards between the extended position and the received position, and a holding down mechanism 204 installed in the front end of the feed pipe 201. The holding down mechanism 204 comprises a pressure block 2042 adapted to hold down the inserted metal rod material 40 in the feed pipe 201, a driving device 2043, and a pressure rod 2041 controlled by the driving device 2043 to move upwards or downwards relative to the pressure block 2042, causing the pressure block 2042 to hold down or release the metal rod material 40 in the feed pipe 201 (see FIGS. 7˜9).

With reference to FIGS. 4˜6, when one fixture 31 moved to the material cut-off shaft assembly 4, the provided metal rod material 40 is delivered forwards by the material feed unit 20 through the feed pipe 201 and held down by the fixture 31, and then the metal rod material 40 is cut by the cutting tool 46 of the material cut-off shaft assembly 4, enabling each cut piece of the metal rod material 40 to be used as a workpiece 401, which is then carried by the fixture 31 to the processing shaft assemblies 5 to receive different processing processes. The rotary center fixture holder 3 is rotated step by step to let workpieces 401 which are respectively held on the fixtures 31 be processed or handled by the shaft assemblies 4, 5, and 6. During processing, waste material falls to the waste material conveyer 30, and then carried out of the machine base 1. After several cuts, the residual metal rod material 402 becomes too short to be used. At this time, the pressure rod 2041 controlled by the driving device 2043 to release the metal rod material 20, and the power unit 203 is controlled by the control box of the cutting metal-working machine to drive the pipe carrier 202 to move the feed pipe 201 backwards to the received position, enabling the residual metal rod material 402 to fall from the feed pipe 201.

As indicated above, the material feed unit 20 uses the holding down mechanism 204 to hold down the provided metal rod material 40 positively in position for cutting by the cutting tool 46 of the material cut-off shaft assembly 4, enabling the cutting tool 46 to cut the provided metal rod material 40 without vibration.

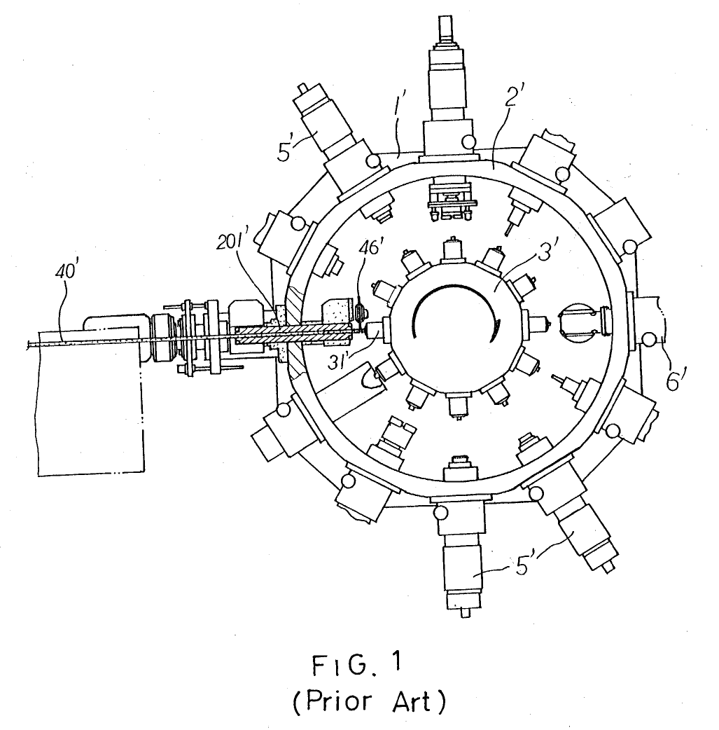

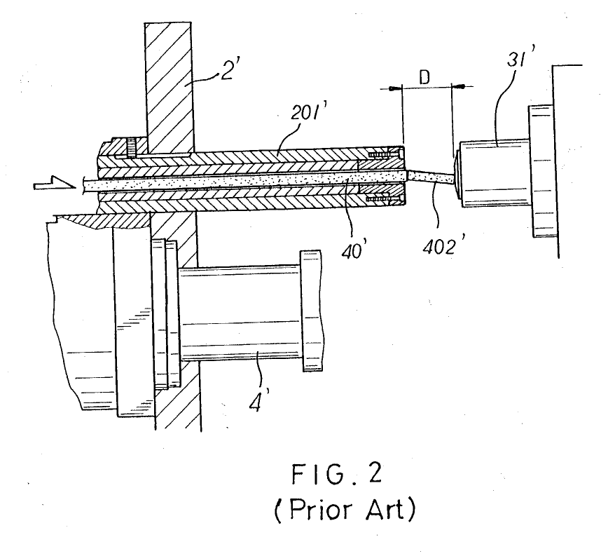

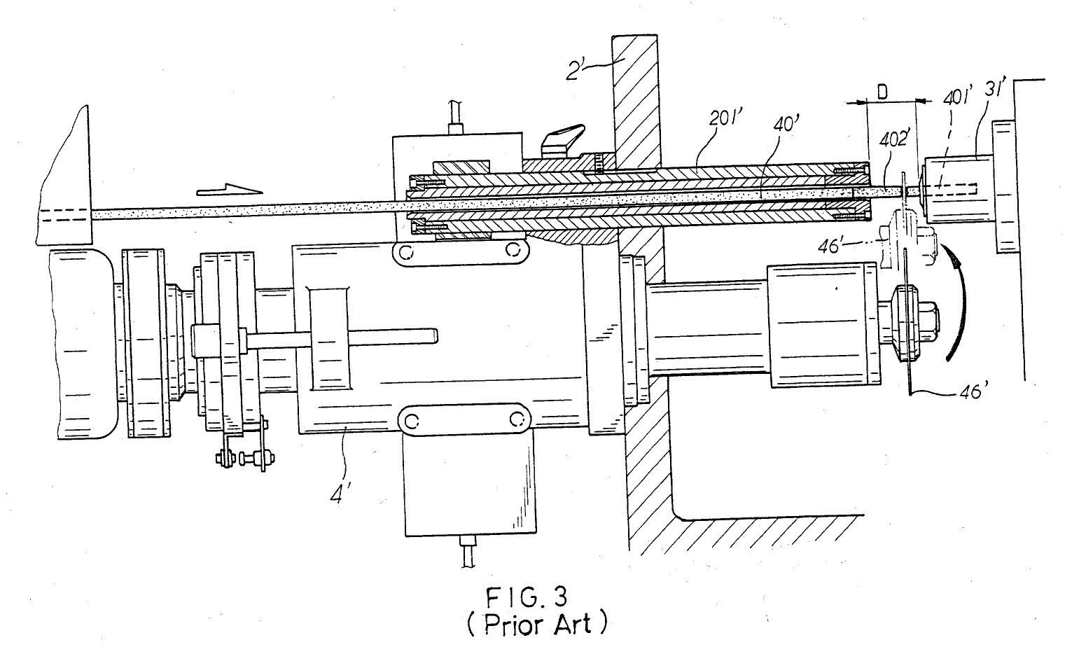

A prototype of fully automatic cutting metal-working machine has been constructed with the features of FIGS. 1˜9. The fully automatic cutting metal-working machine functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A fully automatic cutting metal-working machine comprising a material feed unit adapted to feed a metal rod material for processing, said material feed unit comprising a feed pipe for feeding a metal rod material for processing, a cutting metal-working main unit controlled to process the metal rod material fed by said material feed unit into finished products, and a waste material conveyer controlled to collect and carry waste material out of said cutting metal-working main unit, said cutting metal-working main unit comprising a machine base, a casing mounted on said machine base, a material cut-off shaft assembly controlled to cut the provided metal rod material into individual workpieces, a plurality of processing shaft assemblies mounted around said casing, a rotary center fixture holder mounted within said casing at the center and controlled to carry workpieces individually to each of said processing shaft assemblies in proper order to receive a respective processing procedure, and a steering shaft assembly controlled to reverse the position of the workpiece at each fixture of said rotary center fixture holder, wherein said material feed unit comprises a pipe carrier carrying said feed pipe, and a power unit controlled to drive said pipe carrier to move said feed pipe forwards/backwards relative to said rotary center fixture holder between an extended position and a received position.

2. The fully automatic cutting metal-working machine as claimed in claim 1 wherein said material feed unit further comprises a holding down mechanism installed in a front end of said feed pipe and adapted to hold down the metal rod material being inserted into said feed pipe for cutting by said material cut-off shaft assembly, said holding down mechanism comprising a pressure block adapted to hold down the inserted metal rod material in said feed pipe, a pressure rod, and a driving device adapted to drive said pressure rod upwards/downwards relative to said pressure block, causing said pressure block to hold down/release the inserted metal rod material.
